(19) United States
(12) Patent Application Publication
(10) Pub. No.: US 2015/0355927 A1
(43) Pub. Date: Dec. 10, 2015

(54) AUTOMATIC VIRTUAL MACHINE RESIZING TO OPTIMIZE RESOURCE AVAILABILITY

(71) Applicant: Yahoo! Inc., Sunnyvale, CA (US)

(72) Inventor: Jeff Budzinski, San Jose, CA (US)

(21) Appl. No.: 14/296,341

(22) Filed: Jun. 4, 2014

(51) Int. Cl. G06F 9/455

(52) U.S. Cl. CPC G06F 9/45558; G06F 2009/4557; G06F 2009/45595

(57) ABSTRACT

In one embodiment, a configuration associated with an application may be ascertained, where the configuration indicates a number of instances and a first instance type. Requests associated with the application may be routed among two or more sets of instances, where each of the two or more sets of instances have a different, corresponding instance type of two or more instance types including the first instance type. Metrics associated with the routing of requests to each of the two or more sets of instances may be obtained. The metrics may be analyzed to identify an optimal instance type for the application. Further requests associated with the application may be routed to a set of the number of instances having the optimal instance type.

### BACKGROUND

The disclosed embodiments relate generally to methods and apparatus for identifying optimal instance types for virtual machines.

In cloud computing environments, hardware virtualization is implemented via virtual machines that run on multiple computers. Virtual machines may also be referred to as instances.

Cloud computing hosting services enable users to pay for the use of instances to run their applications on a cloud computing platform. Such services typically enable users to specify a desired number of instances and an instance type of the instances that the user would like the service to run a given application. For example, possible instance types may include small, medium, large, x-large, and xx-large. Each instance type will provide a particular amount of resources at a corresponding cost per time period (e.g., per hour).

### SUMMARY

The disclosed embodiments enable an optimal instance type associated with an application to be determined. Instances associated with the application may then be resized according to the optimal instance type. An instance may also be referred to as a virtual machine.

In accordance with one embodiment, a configuration associated with an application may be ascertained, where the configuration indicates a number of instances and a first instance type. Requests associated with the application may be routed among two or more sets of instances, where each of the sets of instances have a different, corresponding instance type of two or more instance types including the first instance type. Metrics associated with the routing of requests to each of the sets of instances may be obtained. The metrics may be analyzed to identify an optimal instance type for the application.

Further requests associated with the application may be routed to a set of the number of instances having the optimal instance type. Requests associated with the application may no longer be routed to instances of instance types other than the optimal instance type.

In accordance with another embodiment, a configuration associated with an application may be ascertained, where the configuration indicates a number of instances and a first instance type. Two or more sets of instances may be launched in association with the application, where each of the sets of instances have a different, corresponding instance type of two or more instance types including the first instance type. Metrics associated with routing of requests to each of the sets of instances may be obtained. The metrics may be analyzed to identify an optimal instance type for the application.

Instance resizing may be performed for the application automatically or in response to an event such as a user request. More particularly, each of the sets of instances that is not of the optimal instance type may be terminated, and an additional set of instances of the optimal instance type may be launched, resulting in the number of instances of the optimal instance type.

Various embodiments may be implemented via a device comprising a processor and a memory. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is a block diagram illustrating an example instance management system in which various embodiments may be implemented.

FIG. 3A is a process flow diagram illustrating an example method of routing requests in accordance with various embodiments.

FIG. 3B is a process flow diagram illustrating an example method of performing automated instance resizing in accordance with various embodiments.

FIG. 3C is a process flow diagram illustrating an example method of identifying an optimal instance type in accordance with various embodiments.

FIG. 4 is a schematic diagram illustrating another example embodiment of a network in which various embodiments may be implemented.

FIG. 5 is a schematic diagram illustrating an example client device in which various embodiments may be implemented.

FIG. 6 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

It is common for instance types to be selected somewhat arbitrarily by an application developer or deployer during the development of an application's various technologies and deployment tiers. Many of these applications entail performance sensitive end-user applications. When a user selects an instance type that commits more resources than needed to a particular application, this can result in wasted resources and higher costs. Similarly, where a user selects an instance type that does not allocate enough resources to a particular application, this can negatively impact the performance of the application. Accordingly, the user selection of a non-optimal instance type can have a negative impact on overall resource availability and utilization in the cloud.

Many companies release new applications on a daily basis. Moreover, a company may be running many applications at a given point in time. Often, the largest instance type is selected to ensure that performance of the application is not negatively impacted. While the cost savings to such companies could be significant, performing manual testing to determine an appropriate instance type for an application is a significant burden.

The disclosed embodiments enable an optimal instance type for a particular application to be automatically determined. Instances may then be “resized” according to this determination to better utilize resources in the cloud with minimal impact to applications executing in the cloud.

In accordance with various embodiments, the instance resizing may be performed automatically. In this manner, applications may be tuned for resource efficiency without requiring the application developer, deployer, or other user to perform manual or advanced benchmarking. Where instances are resized to a smaller instance type, significant cost savings may be realized.

Systems and methods for implementing the disclosed embodiments will be described in further detail below. In the following description, the terms “instance” and “virtual machine” will be used interchangeably.

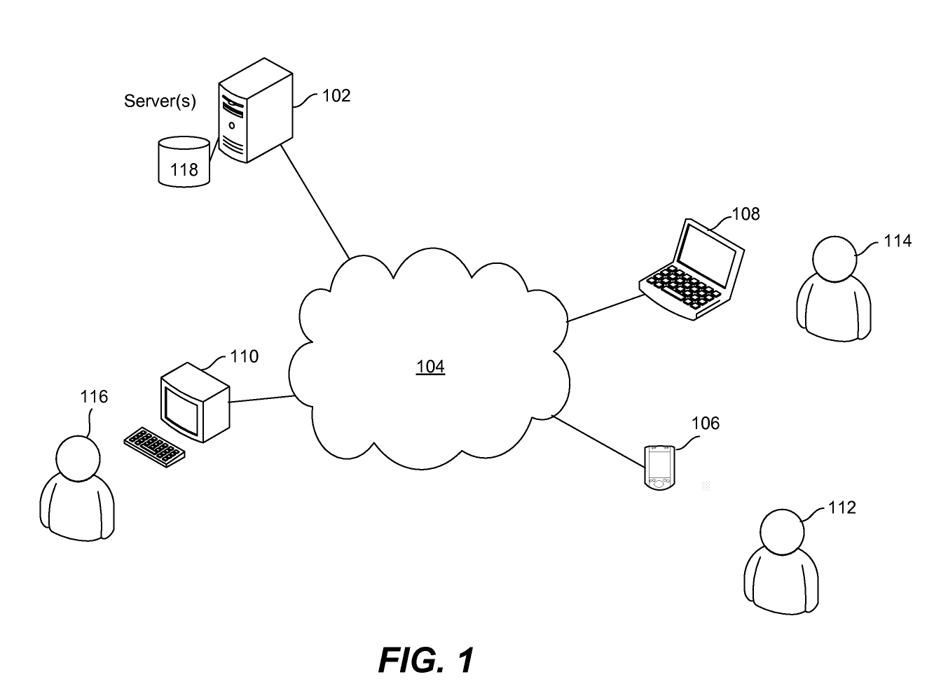

The disclosed embodiments may be implemented in a variety of systems. An example system in which various embodiments may be implemented is described in further detail below with reference to FIG. 1.

Example System

FIG. 1 is a diagram illustrating an example system in which various embodiments may be implemented. As shown in FIG. 1, the system may include one or more servers 102 within a network. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may perform activities such as access user accounts or public user profiles, interact with other members of the web site, transmit messages, upload files (e.g., photographs, videos), purchase goods or services, access information or content posted on the web site, etc.

The server(s) 102 may enable users to run their applications via a cloud computing platform. More particularly, the server(s) 102 may provide a graphical user interface that enables users to submit a desired configuration in association with a particular application. Typically, a configuration is received in association with a machine image, which includes the application and operating system. Such configurations may be received via the Internet 104 from one or more devices 106, 108, 110 in association with corresponding users 112, 114, 116, respectively.

A configuration may indicate a desired number of instances and a desired instance type associated with the instances. For example, the desired instance type may be selected from one of a plurality of instance types. In addition, the configuration may indicate a desired start time at which execution of the application is desired, as well as a length of time during which use of the instances is desired.

The server(s) 102 may support the automated determination of an optimal instance type for use with an application. In accordance with various embodiments, the server(s) 102 may initiate the launch of instances of two or more instance types, collect one or more metrics during execution of the application using the instances, and use the collected metrics to determine the optimal instance type for use with the application. Accordingly, through the automated application of such instance type optimization tests, it is possible to identify the optimal instance type for executing a particular application.

The server(s) 102 may consider the desired instance type and smaller instance types in making the determination of the optimal instance type. In some embodiments, the server(s) 102 may also consider larger instance types in making the determination of the optimal instance type.

In accordance with various embodiments, the server(s) 102 may automatically resize the instances to the optimal instance type. More particularly, the server(s) 102 may cause each instance of a non-optimal instance type to be stopped or eliminated (e.g., deactivated or deleted). In addition, the server(s) may initiate the launch of further instances of the optimal instance type such that the desired number of instances of the optimal instance type have been generated and launched.

Automated resizing may be performed to resize instances to a smaller instance size. Since resizing instances to a smaller instance size will result in a lower cost to the user, it may be assumed that the user prefers the instance resizing to be automatic and immediate. However, since automated resizing to a larger instance size will generally increase the cost to the user, the user may prefer not to have automated instance resizing be performed to increase the instance size.

In accordance with various embodiments, the server(s) 102 may provide a graphical user interface enabling users to opt-in to automated instance resizing. In addition, the circumstances under which automated instance resizing is desired may be indicated or specified by the user. More particularly, the user may indicate whether automated instance resizing is to be performed if the instance size is being increased. For example, the user may wish to simply be notified if the optimal instance size is larger than the instance size configured by the user.

The server(s) 102 may have access to one or more data stores 118 that are coupled to the server(s) 102. Each of the data stores 118 may include one or more memories. The data stores 118 may store account information (e.g., data) for a plurality of user accounts, applications, and data that is pertinent to the operation of the applications. In addition, the server(s) 102 may store information to the data stores 118 such as metrics or analysis thereof, scheduling policies or models, schedules, and/or other information supporting the automated determination of optimal instance types and/or the automated resizing of instance types.

The account information retained in the data stores 118 may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. For example, the account information may indicate a number of instances and an instance type that have been configured or are currently executing in association with a particular application. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)).

In accordance with various embodiments, the user profile may indicate preferences of the user with respect to the execution of applications on a cloud computing platform. For example, the preferences of the user may indicate whether the user has opted in to automated instance resizing. As another example, the preferences of the user may indicate whether automated instance resizing is to be performed for resizing to smaller instance sizes and/or larger instance sizes.

### Example Embodiments

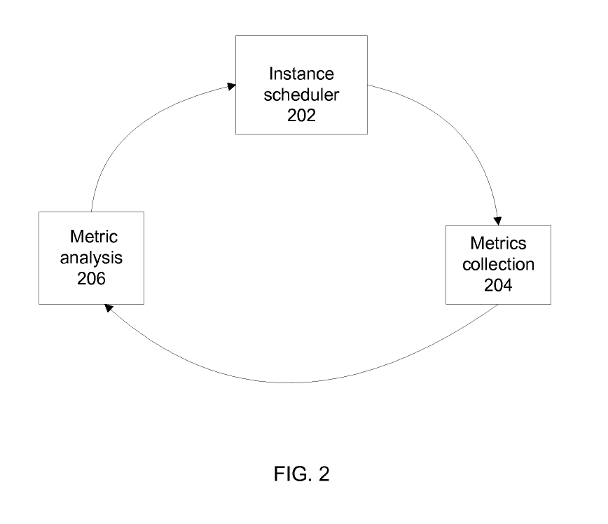

FIG. 2 is a block diagram illustrating an example system in which various embodiments may be implemented. An instance scheduler 202 may initiate the launch of instances of two or more instance types including the desired user-configured instance type. For example, the scheduler may launch the user-configured number of instances. In one embodiment, the two or more instance types include only the user-configured instance type and instance types that are smaller than the user-configured instance type. In another embodiment, the two or more instance types may include the user-configured instance type and instance types that are smaller and/or larger than the user-configured instance type.

Metrics collection 204 may be performed to collect one or more metrics pertaining to execution of the application with respect to each of the two or more instance types. The metrics may be collected for usage of physical and/or virtual resources. Each metric may be recorded in association with an application identifier.

At least a portion of the metrics may pertain to resource usage by instances. Thus, at least a portion of the metrics may be generated by instances. These metrics may be recorded in association with an instance identifier and/or instance type.

Each of the metrics may be collected over time on a periodic basis. For example, the metrics may be collected every hour, minute, or second over a period of minutes, hours, days, weeks, months, or years. Each metric may be recorded in association with a timestamp. At least a portion of the metrics may be recorded in a web server log. In addition, at least a portion of the metrics may be collected via a metrics collection system configured to record, send, or retrieve metrics.

An application may be a serving application that serves requests received from end users. Thus, the metrics may include one or more metrics generated from end-user activity, thereby reflecting the impact of instance type selection on the end users. More particularly, the metrics may include one or more application-specific metrics such as number of user requests, end user latency, and/or user response to end user latency. The end user latency of an end user request may indicate a time period between receipt of the end user request by the application and a response time at which a response satisfying the end user request is provided to the end user. The user response to the end user latency may be measured, for example, by ascertaining a click-through rate, a change in click-through rate, a number of user requests, or a change in the number of user requests. Therefore, the metrics associated with each of the two or more instance types may indicate an end user latency experienced by users whose requests were processed by instances of the corresponding instance type, a number of user requests received by instances of the corresponding instance type, and/or a user response to end user latency.

Each of the metrics may be gathered over a period of time. For example, a metric may be an average or mean value over a particular period of time. As another example, a metric may be an nth percentile.

Metrics analysis 206 may be performed to identify an optimal instance type for the application. More particularly, the optimal instance type may be identified based, at least in part, upon the metrics (e.g., average latency) associated with each of the two or more instance types. This may be accomplished by applying one or more policies (i.e., rules) for identifying an optimal instance type. Such policies may be applied separately or in combination with one another.

A policy may treat metrics of the user-configured instance type as the baseline. The policy may then compare metrics of other instance types with the baseline to identify the optimal instance type.

In accordance with various embodiments, the metrics of an instance type may be compared with the baseline to obtain a differential value. For example, the average end user latency of other instance types may be compared against the baseline average end user latency to ascertain corresponding differential values. The differential values may then be compared to a pertinent threshold value representing an acceptable amount of deviation from the baseline.

In accordance with various embodiments, a policy may determine whether metrics of an instance type other than the user-configured instance type deviates an acceptable amount from the baseline (e.g., according the pertinent threshold value). If not, the user-configured instance type may be deemed to be the optimal instance type. If the metrics of at least one other instance type deviates an acceptable amount from the baseline, the policy may select the smallest instance type for which the metrics produce an acceptable deviation from the baseline (e.g., according to a threshold value) as the optimal instance type.

Reducing the size of the instance type will generally reduce the cost to the user. Similarly, increasing the size of the instance type will typically increase the cost to the user. Therefore, in some embodiments, the identification of the optimal instance type may be determined based, at least in part, upon whether an instance type being considered is larger or smaller than the user-configured instance type.

In some embodiments, the policies may include a first set of policies for determining whether an instance type that is larger than the user-configured instance type is optimal and a second set of policies for determining whether an instance type that is smaller than the user-configured instance type is optimal. More particularly, each set of policies may have associated therewith a corresponding threshold value to be applied. For example, the first set of policies may have associated therewith a first threshold, while the second set of policies may have associated therewith a second threshold.

For instance types that are larger than the user-configured instance type, a differential value from the baseline will indicate improved performance. For example, the metrics of a larger instance type may indicate improved performance in the form of a reduction in average latency experienced by end users. Thus, the differential values of the larger instance types may be compared to the first threshold value, which may indicate a minimum improvement in performance that is acceptable for instance types that are larger than the user-configured instance type.

Where the instance types being “tested” include the user-configured instance type and larger instance types, but do not include smaller instance types, the policy may identify the smallest instance type that produces a deviation from the baseline that exceeds the first threshold value as the optimal instance type. For example, the policy may identify the optimal instance type as the smallest instance type for which the average end user latency is less than the baseline and deviates at least an acceptable threshold amount (e.g., specified by the first threshold value). Accordingly, the smallest instance type for which the metrics indicate an acceptable performance improvement with respect to the baseline may be identified as the optimal instance type.

In contrast, for instance types that are smaller than the user-configured instance type, a differential value will indicate a reduction in performance. For example, the metrics of a smaller instance type may indicate a reduction in performance in the form of an increase in average latency experienced by end users. Thus, the differential values of the smaller instance types may be compared to the second threshold value, which may indicate a maximum reduction in performance that is acceptable for instance types that are smaller than the user-configured instance type.

Where the instance types being “tested” include the user-configured instance type and smaller instance types, but do not include larger instance types, the policy may identify the smallest instance type that produces a deviation from the baseline that is less than the second threshold value as the optimal instance type. For example, the policy may identify the smallest instance type for which the average end user latency is higher than the baseline but deviates within an acceptable amount (e.g., specified by the second threshold value). Accordingly, the smallest instance type for which the metrics indicate an acceptable performance degradation with respect to the baseline may be identified as the optimal instance type.

Since reducing the instance type will result in lower costs to the user, the second threshold value associated with the second set of policies may be set to a small value since a reduction in cost may outweigh a reduction in performance. In contrast, since increasing the instance type will typically result in increased costs to the user, the first threshold value associated with the first set of policies may be a larger value (e.g., larger than the second threshold value) to ensure that the improvement in performance justifies the increase in cost.

In accordance with other embodiments, a policy may identify the smallest instance type for which the metrics satisfy a target amount. For example, the target amount may be an average end user latency that is deemed acceptable. Thus, the optimal instance type may be the smallest instance type for which the average end user latency is less than or equal to the target amount. As another example, the target amount may be a goal of an average number of requests processed per second. Therefore, the optimal instance type may be the smallest instance type for which the average number of requests processed per second is greater than or equal to the target amount.

In accordance with yet other embodiments, a policy may identify the instance type providing optimal performance as the optimal instance type. For example, the policy may identify the instance type providing the lowest latency as the optimal instance type.

The policies may also consider additional factors. For example, user-specified preferences may be considered by the pertinent policies. As another example, the particular cost or cost differential associated with an instance type may also be considered by the pertinent policies.

The instance scheduler 202 may then perform instance resizing according to the optimal instance type. In some embodiments, the scheduler may perform automated instance resizing. In other embodiments, where the optimal instance type is larger than the desired user-configured instance type, the scheduler 202 may provide notification of the optimal instance type to the user and perform instance resizing to the optimal instance type upon receiving confirmation from the user that they are willing to pay the increased fees. Instance resizing may include launching instances of the optimal instance type and deactivating instances of all other instance types deemed to be non-optimal, resulting in the desired number of instances in the optimal instance type being activated.

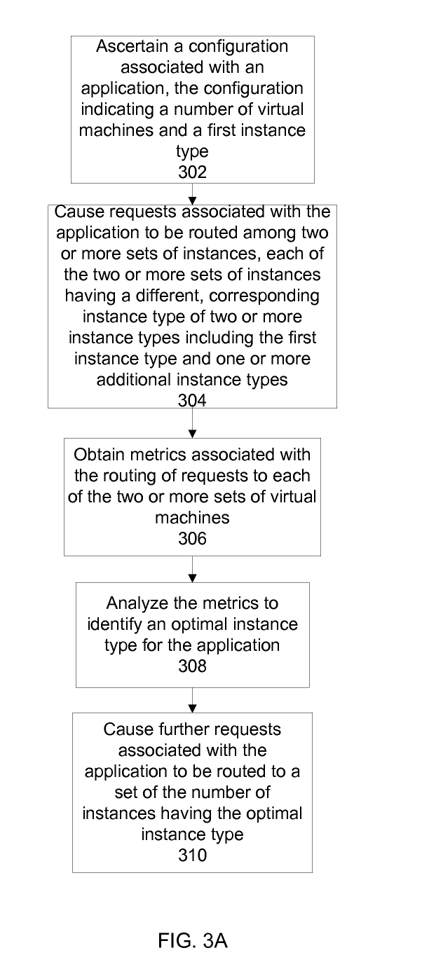

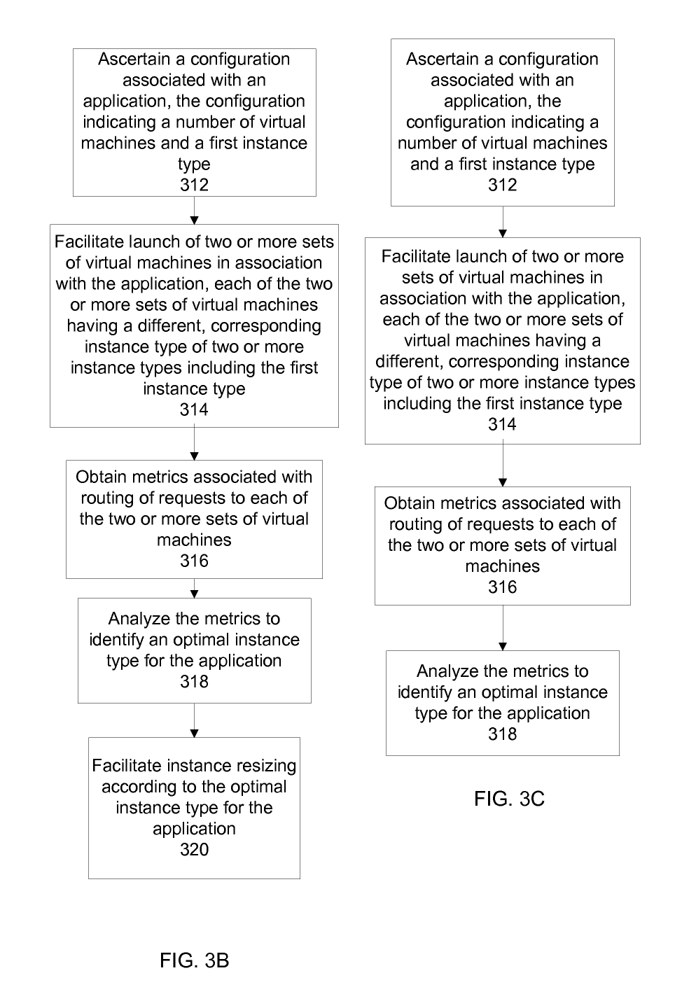

FIG. 3A is a process flow diagram illustrating an example method of routing requests in accordance with various embodiments. A configuration associated with an application, may be ascertained at 302, where the configuration indicates a number of instances and a first instance type. Requests associated with the application may be routed among two or more sets of instances at 304, where each of the two or more sets of instances have a different, corresponding instance type of two or more instance types including the first instance type and one or more additional instance types. More particularly, a scheduler may launch the two or more sets of instances, enabling requests to be routed among the two or more sets of instances. One or more metrics associated with the routing of requests to each of the two or more sets of instances may be obtained at 306. For example, the metrics may be collected during a particular period of time. The metrics may be analyzed at 308 to identify an optimal instance type for the application. Further requests associated with the application may be routed at 310 to a set of the number of instances having the optimal instance type. More particularly, the scheduler may eliminate each set of instances that is not of the optimal instance type and launch one or more additional instances of the optimal instance type.

To facilitate the routing of requests, a scheduler may perform an instance resizing process, as will be described in further detail below. An instance resizing process may be performed for an application in response to various conditions such as a software deployment or update. In addition, an instance resizing process may be performed for an application on a periodic basis. Various example methods of implementing instance resizing will be described in further detail below with reference to FIG. 3B and FIG. 3C.

FIG. 3B is a process flow diagram illustrating an example method of performing automated instance resizing in accordance with various embodiments. A configuration associated with an application may be ascertained at 312. More particularly, the configuration may indicate a number of instances and a first instance type (.e., default instance type). The configuration may be specified, selected, or otherwise indicated by a user via a graphical user interface, as described above. For example, the configuration may indicate that 1000 instances of default instance type, extra-large, are desired.

A scheduler may facilitate the launch of two or more sets of instances in association with the application at 314, where each set of instances has a different, corresponding instance type of two or more instance types including the user-configured instance type. For example, the instance types may include small, medium, large, and extra-large. The total number of instances among the sets of instances may be equal to the user-configured number of instances. The sets of instances may each include an approximately equal number of instances. Requests associated with the application may then be routed among the two or more sets of instances.

In accordance with various embodiments, the scheduler may transmit instructions to the cloud, where the instructions indicate the instance types and number of instances of each instance type to be launched. A hypervisor or instance monitor (VMM) may then create and run the specified number of instances of each instance type, as instructed by the scheduler. More particularly, each instance may be an instantiation of an operating system and an application with a particular instance size parameter.

The instance types to which requests are routed may include the first instance type configured by the user, as well as one or more additional instance types. The additional instance types may include smaller instance types and/or larger instance types. In some embodiments, the additional instance types may include smaller instance types, but may not include larger instance types.

One or more metrics associated with the routing of requests to each of the sets of instances may be obtained at 316. The metrics associated with each instance and/or instance type may be generated or collected periodically, and maintained in association with the application. The metrics may be collected over a period of seconds, minutes, hours or days. Example metrics that may be collected for each instance type include, but are not limited to, number of requests (i.e., queries), average Central Processing Unit (CPU) usage, average Input/Output (I/O) (e.g., disk I/O or network I/O), end-user latency, user response to end-user latency, average memory usage, and cost. In some embodiments, such metrics may be represented as an average value for a particular period of time (e.g., second), a mean value for the period of time, or an nth percentile. For example, the number of requests may be represented as an average number of requests per second. The metrics that are collected or maintained may also indicate a difference in performance between instances of a particular instance type and instances of the user-configured instance type. Each of the metrics may be stored in association with a time at which the metric was collected, the particular instance and/or the corresponding instance type.

For example, for a period of 3 hours, the end-user latency (e.g., the time it takes for the instance to process the request) may be recorded in association with the particular instance and/or the corresponding instance type. Thus, the end-user latency may be recorded for instances of types small, medium, large, and extra-large.

At the conclusion of the measurement period during which the metrics are collected, the metrics may be analyzed at 318 to identify an optimal instance type for the application. For example, the average, mean and/or nth percentile of the end-user latency values corresponding to each instance type may be calculated. In some embodiments, the optimal instance type may be the same size as the first instance type configured by the user, smaller than the first instance type configured by the user, or larger than the first instance type configured by the user. In other embodiments, the optimal instance type may be either the same size or smaller than the first instance type configured by the user, but cannot be larger than the first instance type configured by the user.

The policies that are applied to identify the optimal instance type may operate according to various algorithms, as discussed above. In addition, the policies may consider various factors. For example, the policies may consider the metrics associated with the various instance types, costs associated with the instance types, and/or user preferences. Therefore, the policies may balance various factors such as performance during execution of the application (e.g., latency), resource conservation, and/or cost to the user.

In accordance with various embodiments, the optimal instance type may be a smallest instance type for which the metrics, when compared to the metrics of the first instance type, indicate a differential value that is an acceptable deviation from the baseline. Of course, if the metrics of none of the other instance types deviates an acceptable amount from the baseline, the user-configured instance type will be deemed the optimal instance type. The deviation that is considered acceptable for a particular metric may be represented by a threshold.

For example, consider that the mean and 95^{th} percentile are calculated for the end-user latency experienced by instances of each instance type (e.g., small, medium, large, and extra large). The threshold for the mean end-user latency may be 5 percent above the end-user latency experienced by the extra large instances, while the threshold for the 95^{th} percentile may be 10 percent above the value for the extra large instances. A policy may select the instance type having the least cost (e.g., currency or otherwise) for which the mean end-user latency is no greater than 5 percent above the baseline and the 95^{th} percentile is no greater than 10 percent above the baseline. Consider the following metrics for each instance type:

| Type | Mean | 95^{th} percentile | Cost |
|---|---|---|---|
| X-large | 100 | 250 | 0.12 |
| Large | 102 | 256 | 0.10 |
| Medium | 103 | 258 | 0.08 |
| Small | 105 | 300 | 0.06 |

In this example, the policy would select the medium instance type as the new default instance type.

The threshold that is applied may vary depending upon whether the instance type being considered is larger or smaller than the first, user-configured instance type. In some implementations, the threshold that is applied for larger instance types may be a larger value than the threshold that is applied for smaller instance types. Therefore, the policies may favor reduction in the instance size over an increase in the instance size.

The policies that are applied may consider smaller instance types. Of course, where the user-selected instance type is the smallest instance type available, the policies will not consider other smaller instance types. Where an instance type is smaller than the user-configured instance type, the corresponding differential value may indicate an amount of degradation in performance. The policy may identify the optimal instance type as the smallest instance type for which the metrics, when compared to the metrics of the user-configured instance type, provides a degradation in performance (e.g., increase in average end-user latency) that is within an acceptable threshold amount. Therefore, the policies may seek to conserve resources while minimizing user cost and performance degradation.

In some embodiments, the policies may also consider instance types that are larger than the user-configured instance type. Of course, where the user-selected instance type is the largest instance type available, the policies will not consider other larger instance types. Where an instance type is larger than the user-configured instance type, the corresponding differential value may indicate an amount of improvement in performance. Thus, the policy may identify the optimal instance type as the smallest instance type for which the metrics, when compared to the metrics of the first instance type, indicate an improvement in performance that meets or exceeds a particular threshold. In this manner, the policies may seek to improve application performance while minimizing resource usage and user cost.

In yet other embodiments, a policy may select the instance type providing optimal performance (e.g., better performance metrics than the other instance types) as the optimal instance type. For example, the instance type providing the lowest average end user latency may be selected as the optimal instance type.

In some embodiments, the analysis of the metrics may be performed based, at least in part, upon user preferences. For example, the user preferences may indicate that the user is willing to pay for a set of instance types (e.g., x-small-large) and/or not willing to pay for other instance types (e.g., xx-large). In this manner, the optimal instance type may be identified based, at least in part, upon user preferences.

The above-described examples are merely illustrative. Therefore, other or additional policies or factors not set forth herein may also be applied to select the optimal instance type.

The scheduler may facilitate instance resizing according to the optimal instance type. More particularly, the scheduler may cause each set of instances not having the optimal instance type to terminate and cause one or more instances having the optimal instance type to launch at 320 such that a set of the number of instances having the optimal instance type is running. Further requests associated with the application may be routed to the set of the number of instances having the optimal instance type. Accordingly, requests associated with the application may no longer be routed to instances of instance types other than the optimal instance type.

In accordance with various embodiments, the scheduler may transmit instructions to the cloud. The instructions may indicate the number of instances to be activated, as well as the optimal instance type. A hypervisor or VMM may stop and deactivate instances of the non-optimal instance type, and create and run an equivalent number of instances of the optimal instance type, as instructed by the scheduler.

In some embodiments, all requests that are subsequently received in association with the application may be routed to instances of the optimal instance type. However, an application may consume different amounts of resources at different times of the day, week, or year. As a result, the optimal instance type may vary over time. Thus, the process may repeat at 312 to ensure that requests are routed to instances of an instance type that is suitable for the current level of resource consumption of the application. The user may be charged according to the optimal instance type used during a period of time rather than the user-configured instance type.

Automated instance resizing may be performed based, at least in part, upon user preferences. For example, the user preferences may indicate that the user prefers that the instance resizing be automatic if the optimal instance size is smaller than the user-configured instance size, but wishes to be notified prior to resizing to a larger instance size than the user-configured instance size.

As described above with reference to FIG. 3B, the scheduler may perform automated instance resizing. In other embodiments, an optimal instance type may be identified, enabling instance resizing to be performed according to user input.

FIG. 3C is a process flow diagram illustrating an example method of identifying an optimal instance type in accordance with various embodiments. As described above, a configuration associated with an application may be ascertained at 312. A scheduler may facilitate the launch of two or more sets of instances in association with the application at 314, where each set of instances has a different, corresponding instance type of two or more instance types. Requests associated with the application may then be routed among the two or more sets of instances. Metrics associated with the routing of requests to each of the sets of instances may be obtained at 316 and analyzed at 318 to identify an optimal instance type for the application.

Information indicating the optimal instance type may be provided for presentation to a user. In addition, the information may also indicate a cost associated with the optimal instance type or a cost differential between the optimal instance type and the user-configured instance type. Input indicating whether the user wishes to proceed with instance resizing according to the optimal instance type may then be received. For example, the user may wish to proceed with instance resizing according to the optimal instance type. As another example, the user may indicate that he or she wishes to proceed with the user-configured instance size or another instance size. Accordingly, instance resizing may be performed according to the user input.

Although the above-described embodiments discuss the identification of an optimal instance type, it is important to note that these examples are merely illustrative. As a result, more than one optimal instance type that provides improved performance over the user-configured instance type may be identified. Therefore, a user may be presented two or more instance types from which a user may select.

One scenario in which it may be desirable to present two or more instance types from which a user can select is when an instance type providing the greatest performance improvement (e.g., reduced latency) is a larger instance type than the user-configured instance type. In such a situation, it may be desirable to provide another alternative that may be more desirable (e.g., less costly) to the user. For example, suppose the user specifies an instance type x-small. The instance type determined to be the optimal instance type may be an instance type large. It may therefore be desirable to provide the user with a list of two or more instance types that would provide a performance benefit with respect to the application. In this situation, a list of candidate instance types including small, medium, and large may be presented to the user. In addition, metrics associated with the candidate instance types may also be provided to the user, enabling the user to make an informed decision. For example, the improvement in latency associated with each of the candidate instance types, cost, and/or cost differential from the user-selected instance type may be provided. Upon selection of one of the candidate instance types, instance resizing may be performed according to the selected instance type.

As described above, an optimal instance type associated with an application may be automatically determined. In addition, instances may be activated or deactivated in association with the application to ensure that instances of the optimal instance type are executing the application, Accordingly, resources may be conserved while ensuring that sufficient resources are allocated for execution of the application.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

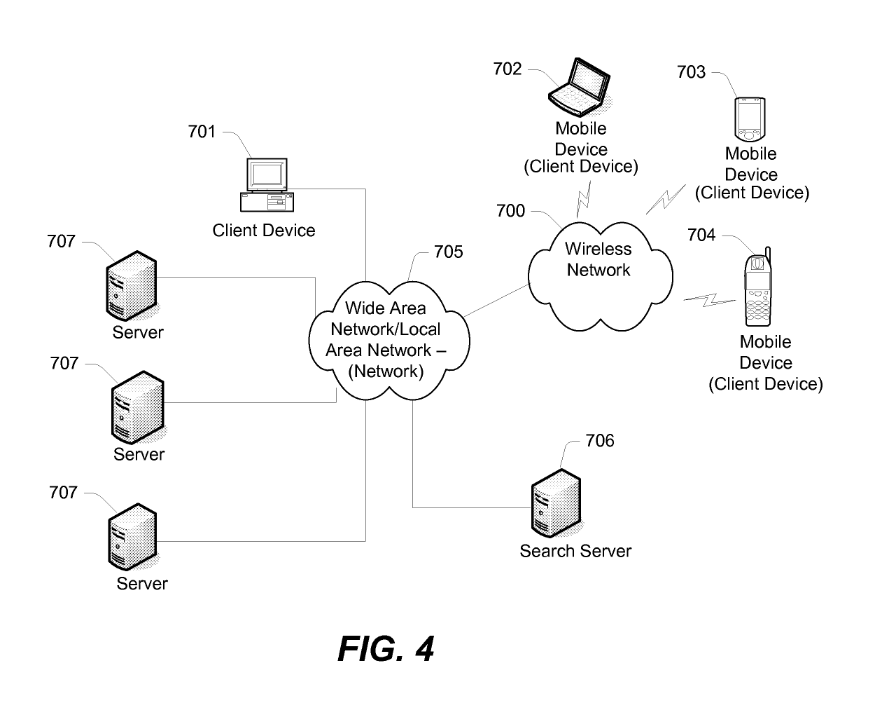

The disclosed embodiments may be implemented in any of a wide variety of computing contexts. FIG. 4 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 4, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 4 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Client Device

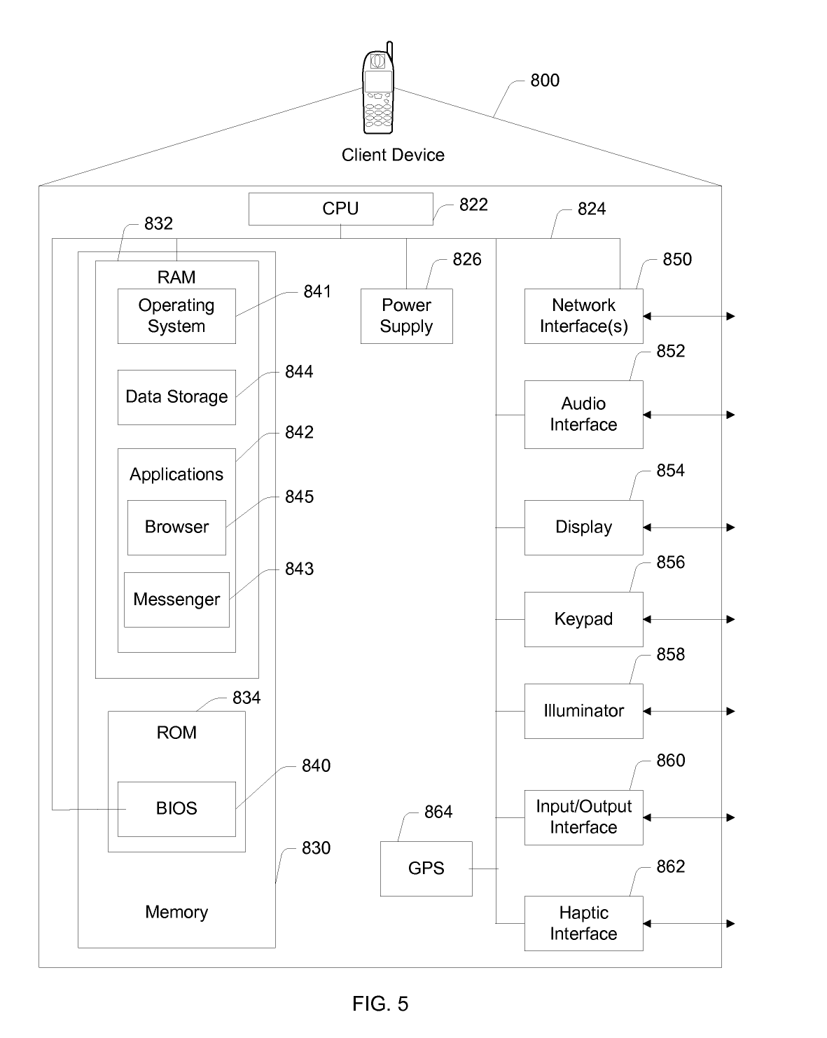

FIG. 5 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may transmit and detect patterns, images, or signals such as infra-red signals via the interface(s). For example, the client device 800 may transmit an infra-red blink pattern, as well as detect an infra-red blink pattern, as described herein.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

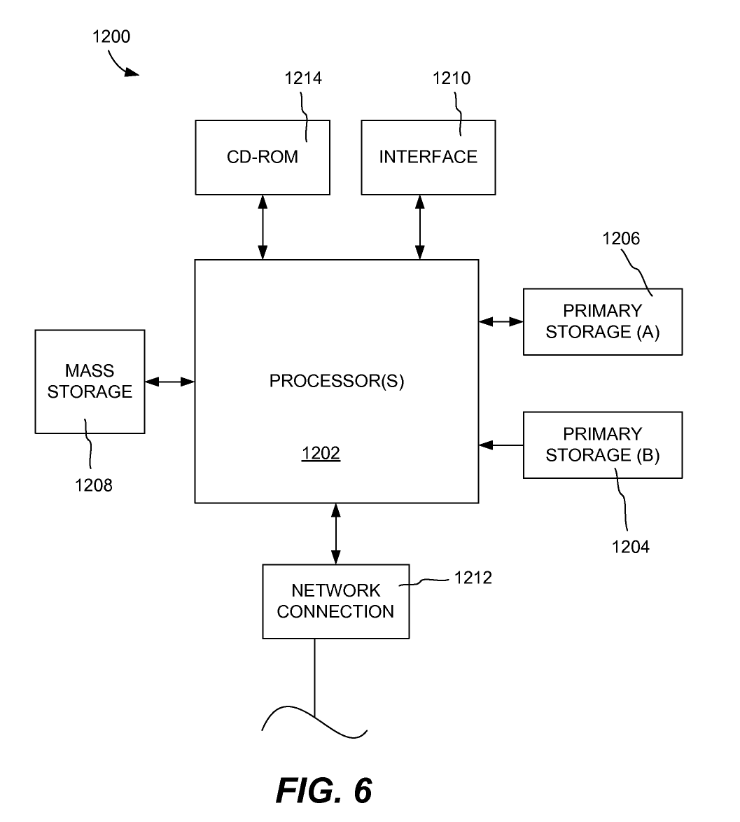

FIG. 6 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
ascertaining a configuration associated with an application, the configuration indicating a number of instances and a first instance type;
facilitating launching of two or more sets of instances in association with the application, each of the two or more sets of instances having a different, corresponding instance type of two or more instance types including the first instance type and one or more additional instance types;
obtaining metrics associated with routing of requests to each of the two or more sets of instances;
analyzing the metrics to identify an optimal instance type for the application; and
facilitating instance resizing according to the optimal instance type.

2. The method as recited in claim 1, wherein facilitating instance resizing comprises:
eliminating each set of the two or more sets of instances not having the optimal instance type and causing one or more additional instances having the optimal instance type to launch such that the number of instances having the optimal instance type are running.

3. The method of claim 1, wherein the two or more instance types include at least one of: at least one instance type that is smaller than the first instance type or at least one instance type that is larger than the first instance type.

4. The method of claim 1, wherein analyzing metrics associated with routing requests to each of the two or more sets of instances to identify an optimal instance type for the application comprises:
ascertaining a first set of metrics associated with a first set of the two or more sets of instances, the first set of instances corresponding to the first instance type; and
ascertaining one or more additional sets of metrics associated with each of the remaining sets of the two or more sets of instances, the remaining sets of instances corresponding to the one or more additional instance types; and
determining whether an instance type of the one or more additional instance types has a set of metrics that, when compared to the first set of metrics, provides a performance differential that is an acceptable amount according to a threshold.

5. The method of claim 1, wherein analyzing metrics associated with routing requests to each of the two or more sets of instances to identify an optimal instance type for the application comprises:
ascertaining a first set of metrics associated with a first set of the two or more sets of instances, the first set of instances corresponding to the first instance type; and
ascertaining one or more additional sets of metrics associated with each of the remaining sets of the two or more sets of instances, the remaining sets of instances corresponding to the one or more additional instance types; and
identifying a smallest instance type of the one or more additional instance types for which a set of metrics, when compared to the first set of metrics, provides a performance differential that is an acceptable amount according to a threshold.

6. The method of claim 1, wherein analyzing metrics associated with routing requests to each of the two or more sets of instances to identify an optimal instance type for the application comprises:
ascertaining a first set of metrics associated with a first set of the two or more sets of instances, the first set of instances corresponding to the first instance type; and
ascertaining one or more additional sets of metrics associated with each of the remaining sets of the two or more sets of instances, the remaining sets of instances corresponding to the one or more additional instance types; and
identifying a smallest instance type of the one or more additional instance types for which a set of metrics, when compared to the set of metrics associated with the first instance type, provides a performance improvement that is greater than a first threshold or a performance degradation that is less than a second threshold.

7. The method of claim 1, wherein the metrics indicate a latency associated with processing the corresponding requests or a user response to the latency.

8. An apparatus, comprising:
a processor; and
a memory, at least one of the processor or the memory being configured for:
ascertaining a configuration associated with an application, the configuration indicating a number of instances and a first instance type;
facilitating launching of two or more sets of instances in association with the application, each of the two or more sets of instances having a different, corresponding instance type of two or more instance types including the first instance type;
obtaining metrics associated with routing of requests to each of the two or more sets of instances; and
analyzing the metrics to identify an optimal instance type for the application.

9. The apparatus of claim 8, at least one of the processor or the memory being configured for performing operations, further comprising:
automatically performing instance resizing according to the optimal instance type such that a set of the number of instances having the optimal instance type is associated with the application.

10. The apparatus of claim 9, at least one of the processor or the memory being configured for performing operations, further comprising:
facilitating instance resizing according to the optimal instance type.

11. The apparatus of claim 8, at least one of the processor or the memory being configured for performing operations, further comprising:
terminating each set of the two or more sets of instances not having the optimal instance type and causing an additional set of instances having the optimal instance type to launch such that the number of instances having the optimal instance type are running.

12. The apparatus of claim 8, at least one of the processor or the memory being configured for performing operations, further comprising:
providing information indicating the optimal instance type;
receiving input pertaining to the information; and
facilitating instance resizing according to the input.

13. The apparatus of claim 8, wherein the two or more instance types comprise at least one of an instance type that is smaller than the first instance type or an instance type that is larger than the first instance type.

14. The apparatus of claim 8, wherein the metrics indicate a latency associated with processing the corresponding requests or a user response to the latency.

15. A system, comprising:
means for ascertaining a configuration associated with an application, the configuration indicating a number of instances and a first instance type;
means for facilitating launching of two or more sets of instances in association with the application, each of the two or more sets of instances having a different, corresponding instance type of two or more instance types including the first instance type;
means for obtaining metrics associated with routing of requests to each of the two or more sets of instances; and
means for analyzing the metrics to identify an optimal instance type for the application.

16. The system of claim 15, further comprising:
means for facilitating instance resizing according to the optimal instance type such that a set of the number of instances having the optimal instance type is associated with the application.

17. The system of claim 15, wherein the two or more instance types include at least one of an instance type that is smaller than the first instance type or an instance type that is larger than the first instance type.

18. The system of claim 15, further comprising:
means for terminating each set of the two or more sets of instances not having the optimal instance type; and
means for causing an additional set of instances having the optimal instance type to launch such that the number of instances having the optimal instance type are running.

19. The system of claim 15, wherein the metrics indicate a latency associated with processing the corresponding requests or a user response to the latency.

20. The system of claim 15, further comprising:
means for providing information indicating the optimal instance type;
means for receiving input pertaining to the information; and
means for facilitating instance resizing according to the input.
